(19) United States
(12) Patent Application Publication
(10) Pub. No.: US 2022/0351495 A1
(43) Pub. Date: Nov. 3, 2022

(54) METHOD FOR MATCHING IMAGE FEATURE POINT, ELECTRONIC DEVICE AND STORAGE MEDIUM

(71) Applicant: Beijing Baidu Netcom Science Technology Co., Ltd., Beijing (CN)

(72) Inventors: Qu CHEN, Beijing (CN); Xiao TAN, Beijing (CN); Xiaoqing YE, Beijing (CN); Hao SUN, Beijing (CN)

(21) Appl. No.: 17/865,261

(22) Filed: Jul. 14, 2022

(30) Foreign Application Priority Data
Sep. 29, 2021 (CN) 202111151056.3

(51) Int. Cl. G06V 10/74; G06T 7/246; G06T 3/40

(52) U.S. Cl. CPC G06V 10/761; G06T 7/248; G06T 3/4038

(57) ABSTRACT

A method for matching an image feature point, an electronic device, and a storage medium are provided. The method may include: for images in an acquired image sequence, performing operations including: obtaining a mapping image of a current image based on mapping transformation information between adjacent images before the current image; determining in the mapping image a target area for matching with a feature point in a last image frame prior to the current image; matching the feature point in the last image frame with a feature point in the target area corresponding to the feature point, to determine matching information between the feature point of the current image and the feature point of the last image frame; and determining mapping transformation information between the current image and the last image frame, based on the matching information.

### CROSS-REFERENCE TO RELATED APPLICATIONS

The present application claims the priority of Chinese Patent Application No. 202111151056.3, titled “METHOD AND APPARATUS FOR MATCHING IMAGE FEATURE POINT, AND COMPUTER PROGRAM PRODUCT”, filed on Sep. 29, 2021, the content of which is incorporated herein by reference in its entirety.

### TECHNICAL FIELD

The present disclosure relates to the field of artificial intelligence, in particular to computer vision and deep learning technologies, and more particular to a method for matching an image feature point, an electronic device, and a storage medium, which may be used in image stitching and image recognition scenarios.

### BACKGROUND

At present, feature matching technologies for fast scanning scenarios generally include the following two kinds: (1) a method based on feature matching, this method performs feature extraction and feature matching on adjacent image frames in an image sequence; (2) a method based on optical flow, this method tracks a feature point by calculating an optical flow of adjacent image frames in an image sequence.

### SUMMARY

The present disclosure provides a method for matching an image feature point, an electronic device, and a storage medium.

According to a first aspect, a method for matching an image feature point is provided, which includes: for images in an acquired image sequence, performing operations including: obtaining a mapping image of a current image based on mapping transformation information between adjacent images before the current image; determining in the mapping image a target area for matching with a feature point in a last image frame prior to the current image; matching the feature point in the last image frame with a feature point in the target area corresponding to the feature point, to determine matching information between the feature point of the current image and the feature point of the last image frame; and determining mapping transformation information between the current image and the last image frame, based on the matching information.

According to a second aspect, an electronic device is provided, which includes: at least one processor; and a memory communicatively connected to the at least one processor; where the memory stores instructions executable by the at least one processor, and the instructions, when executed by the at least one processor, cause the at least one processor to perform the method according to an embodiment of the first aspect.

According to a third aspect, a non-transitory computer readable storage medium storing computer instructions is provided, where the computer instructions when executed by a computer cause the computer to perform the method according to any embodiment of the first aspect.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

The accompanying drawings are used for better understanding of the present solution, and do not constitute a limitation to the present disclosure. In which:

FIG. 1 is an example system architecture diagram to which an embodiment of the present disclosure may be applied;

FIG. 2 is a flowchart of an embodiment of a method for matching an image feature point according to the present disclosure;

FIG. 3 is a schematic diagram of an application scenario of the method for matching an image feature point according to the present embodiment;

FIG. 4 is a flowchart of another embodiment of the method for matching an image feature point according to the present disclosure;

FIG. 5 is a structural diagram of an embodiment of an apparatus for matching an image feature point according to the present disclosure; and

FIG. 6 is a schematic structural diagram of a computer system adapted for implementing embodiments of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

In the technical solution of the present disclosure, the collection, storage, use, processing, transmission, provision and disclosure of the user personal information are all in accordance with the provisions of the relevant laws and regulations, and the public order and good customs are not violated.

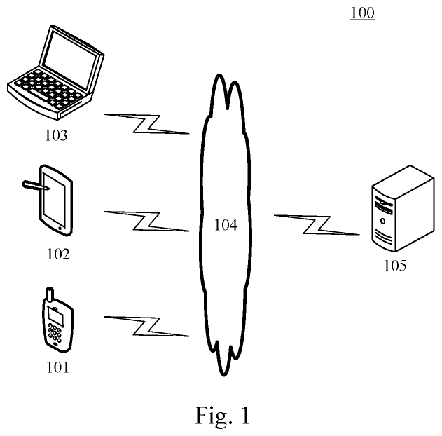

FIG. 1 shows an example architecture 100 to which a method and apparatus for matching an image feature point of the present disclosure may be applied.

As shown in FIG. 1, the system architecture 100 may include terminal devices 101, 102, 103, a network 104 and a server 105. A communication connection among the terminal devices 101, 102 and 103 constitutes a topology network. The network 104 serves as a medium for providing a communication link between the terminal devices 101, 102, 103 and the server 105. The network 104 may include various types of connections, such as wired or wireless communication links, or optical fiber cables.

The terminal devices 101, 102, and 103 may be hardware devices or software that support network connection for data interaction and data processing. When the terminal devices 101, 102, and 103 are hardware, they may be various electronic devices that support network connection, information acquisition, interaction, display, processing and other functions, including but not limited to image scanning devices, vehicle-mounted smart devices, monitoring devices, smartphones, tablet computers, e-book readers, laptops, desktop computers, and the like. When the terminal devices 101, 102, and 103 are software, they may be installed in the electronic devices listed above. They may be implemented, for example, as a plurality of software or software modules for providing distributed services, or as a single software or software module, which is not limited herein.

The server 105 may be a server that provides various services. For example, a backend processing server that receives an image sequence sent by the terminal devices 101, 102, and 103, and based on on motion tracking information between preceding adjacent images, determines in a mapping image of a current image a target area for matching with a feature point in a last image frame prior to the current image, and matches the feature point in the last image frame with a feature point in the corresponding target area. As an example, the server 105 may be a cloud server.

It should be noted that the server may be hardware or software. When the server is hardware, it may be implemented as a distributed server cluster composed of a plurality of servers, or may be implemented as a single server. When the server is software, it may be implemented as a plurality of software or software modules (for example, software or software modules for providing distributed services), or may be implemented as a single software or software module, which is not limited herein.

It should also be noted that the method for matching an image feature point provided by the embodiments of the present disclosure may be performed by the server, the terminal devices, or the server and the terminal devices in cooperation with each other. Correspondingly, the parts (for example, units) included in the apparatus for matching an image feature point may be all provided in the server, may also all be provided in the terminal devices, and may also be provided in the server and the terminal devices respectively.

It should be appreciated that the number of terminal devices, networks and servers in FIG. 1 is merely illustrative. Any number of terminal devices, networks and servers may be provided depending on the implementation needs. When an electronic device on which the method for matching an image feature point is run does not require data transmission with other electronic devices, the system architecture may only include the electronic device (for example, the server or the terminal device) on which the method for matching an image feature point is run.

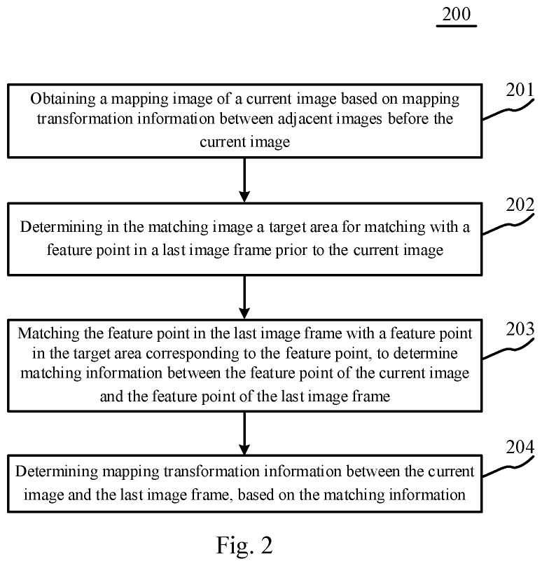

With reference to FIG. 2, FIG. 2 is a flowchart of a method for matching an image feature point provided by an embodiment of the present disclosure. For images in an acquired image sequence, an executing body (for example, the server in FIG. 1) of the method for matching an image feature point may perform the following operations as shown in a flow 200. The flow 200 includes the steps as follows.

Step 201 includes obtaining a mapping image of a current image based on mapping transformation information between adjacent images before the current image.

In the present embodiment, the executing body may acquire the image sequence from remote or local through wired network connection or wireless network connection, and obtain the mapping image of the current image based on the mapping transformation information between the adjacent images before the current image.

The images in the image sequence may be images that include any content. For example, in a face recognition scenario, a to-be-processed image may be a face image acquired by a monitoring device; in an intelligent driving scenario, a to-be-processed image may be an environmental image representing a vehicle surrounding environment acquired by an image acquisition device on an assisted driving vehicle or an autonomous driving vehicle; or in an image scanning scenario, a to-be-processed image is a scanned image obtained by scanning a real object (for example, a book).

The mapping transformation information is used to describe a mapping relationship between points of a given plane in an image and points of the given plane in a different image. For the two images involved in the mapping transformation information, one image may be mapped to the viewing angle of the other image through the mapping transformation information. As an example, the mapping transformation information may be represented in the form of a matrix, which is expressed as a homography matrix.

In processing each image frame in the image sequence, since there are no two adjacent image frames prior to a first image frame or a second image frame, for these first two images in the image sequence, the executing body may determine the mapping transformation information between the first image frame and the second image frame based on the existing feature point matching technology.

As an example, the executing body may use a pre-trained CNN (Convolutional Neural Networks), GNN (Graph Neural Network) or other network models based on the deep learning method to perform feature extraction on the first two image frames; then, determine a distance (for example, the Hamming distance) between a feature point in the first image frame and a feature point in the second image frame; then, determine matched feature points on the basis of the distance, to obtain matching information between the first two image frames; furthermore, on the basis of the matching information, obtains a homography matrix between the first two image frames through RANSAC (Random sample consensus).

Starting from a third image frame in the image sequence, the executing body may determine the matching information and mapping transformation information between the feature point of the current image and a feature point of a last image frame through the steps as shown in steps 201-204.

Under normal circumstances, in a process of scanning a target object by a scanning device to obtain an image sequence, there are certain fluctuations in a amplitude of motion, movement speed and other information of the scanning device, but no sudden changes occur and the information is relatively stable. Based on the prior knowledge that the motion information of the scanning device is relatively stable, it may be determined that the mapping transformation information between preceding adjacent images is similar to the mapping transformation information between subsequent adjacent images. For example, the mapping transformation information between the third image frame and the second image frame, the mapping transformation information between a fourth image frame and the third image frame, the mapping transformation information between a fifth image frame and the fourth image frame, the three pieces of mapping transformation information are similar.

Therefore, the executing body may obtain the mapping image of the current image based on the mapping transformation information between the adjacent images before the current image. That is, an image obtained by mapping the current image to the viewing angle of the last image frame.

In order to make the mapping image of the current image have a higher reference, the mapping transformation information on which the mapping image of the current image is based on may be mapping transformation information between two adjacent image frames that are closest to the current image. For example, for the third image frame, the mapping transformation information on which the mapping image of the third image frame is based on is the mapping transformation information between the second image frame and the first image frame.

Step 202 includes determining in the mapping image a target area for matching with a feature point in a last image frame prior to the current image.

In the present embodiment, the executing body may determine in the mapping image the target area for matching with the feature point in the last image frame prior to the current image.

For example, for each feature point in the last image frame of the current image, the executing body may set a pixel of the mapping image, which has a same pixel coordinate as the feature point (feature point in the last image frame), as the center, and set an area represented by a preset size range as a target area corresponding to the feature point.

The preset size may be set according to an actual situation. For example, when the scanning device has a large amplitude of motion between scans of the adjacent images, a large preset size may be set; when the scanning device has a small amplitude of motion between scans of the adjacent images, a small preset size may be set. In an example, the executing body may determine an average value of amplitudes of the scanning device between scans of the adjacent images, and then multiple the average value by a preset number to obtain the preset size.

It may be understood that the feature points in an image frame is not exactly the same as the features points in the adjacent image frame, but only a part of the feature points in the adjacent image frames are identical, and only the identical features points can be matched.

In some alternative implementations of the present embodiment, the executing body may perform the above step 202 as follows: determining in the mapping image the target area for matching with the feature point in the last image frame prior to the current image, based on a positional distance between matched feature points in the adjacent images before the current image.

First, the executing body may determine pixel coordinates of the matched feature points in the adjacent images before the current image; then, determine a difference between the pixel coordinates of two matched feature points and use the difference as a positional distance between the two matched feature points; and then, obtain an average value of the positional distances between all the matched feature points as the positional distance between the matched feature points in the adjacent images.

For example, for each feature point in the last image frame of the current image, the executing body may set a pixel of the mapping image, which has the same pixel coordinate as the feature point (feature point in the last image frame), as the center, and set an area within a range of the positional distance as the target area corresponding to the feature point.

As another example, in order to cope with fluctuations in the movement speed of the scanning device, the executing body may obtain a final size by adding a preset value or multiplying a preset number on the basis of the positional distance, and further, for each feature point in the last image frame of the current image, the executing body may set a pixel of the mapping image, which has the same pixel coordinate as the feature point (feature point in the last image frame), as the center, and set an area within a range of the final size as the target area corresponding to the feature point.

In the present embodiment, determining in the mapping image the target area for matching with the feature point in the last image frame prior to the current image, based on the positional distance between the matched feature points in the adjacent images before the current image, improves the accuracy of the determined target area, which in turn improves the accuracy of the determination of the matching information.

Step 203 includes matching the feature point in the last image frame with a feature point in the target area corresponding to the feature point, to determine matching information between the feature point of the current image and the feature point of the last image frame.

In the present embodiment, the executing body may match the feature point in the last image frame with the feature point in the target area corresponding to the feature point, to determine the matching information between the feature point of the current image and the feature point of the last image frame.

For example, for each feature point in the last image frame, the executing body may determine a distance (for example, Hamming distance) between the feature point and each feature point in the corresponding target area, and then determine from the target area a feature point matching the feature point in the last image frame based on the feature distance. For example, two closest feature points are determined as matched feature points. After determining the feature point matching each feature point in the last image frame, the executing body may obtain the matching information between the feature point of the current image and the feature point of the last image frame.

In some alternative implementations of the present embodiment, the executing body may perform the above step 203 as follows.

First step includes: determining initial matching information between the feature point in the last image frame and each feature point in the target area corresponding to the feature point.

For example, the initial matching information may be initial matching information obtained based on feature extraction and distance determination between feature points.

Second step includes determining penalty information between the feature point in the last image frame and each feature point in the target area corresponding to the feature point, based on motion information of a scanning process of the adjacent images before obtaining the current image.

For example, generally, the motion information of the scanning process of the adjacent images is relatively stable and may not undergo sudden changes. Based on this, for each feature point in the last image frame, in the process of matching the feature point with the feature point in the corresponding target area, a distance between the feature point in the target area and a center point is positively correlated with the penalty information. That is, when the distance between the feature point and the center point is larger, the penalty information corresponding to the feature point is larger.

Third step includes determining the matching information, based on the initial matching information and the penalty information between the feature point in the last image frame and each feature point in the target area corresponding to the feature point.

In particular, the executing body may add the initial matching information with the penalty information to determine the matching information.

The initial matching information may be, for example, the Hamming distance between the feature points, and the penalty information is added on the basis of the Hamming feature distance to obtain an adjusted Hamming distance between the feature point in the last image frame and each feature point in the target area corresponding to the feature point, and then, the matched feature points are determined based on the adjusted Hamming distance to obtain the matching information.

In this implementation, based on the motion information of the scanning process, the executing body may determine the penalty information of different feature points in the target area in the matching process, which avoids the situation of matching errors caused by repeated textures in the image, and improves the accuracy of the matching information.

In some alternative implementations of the present embodiment, the executing body may perform the above second step as follows: determining, for the feature point in the last image frame, the penalty information between the feature point in the last image frame and each feature point in the target area corresponding to the feature point, by using a preset penalty function based on position information of the feature point, the positional distance between the matched feature points in the adjacent images before the current image, and the mapping transformation information between the adjacent images before the current image.

The preset penalty function represents a corresponding relationship between the motion information of the scanning process and the penalty information.

As an example, the preset penalty function may be expressed as:

Penalty=F1(x_t−1,y_t−1,mean_dx,mean_dy,h)

Penalty represents the obtained penalty information, F1 represents the preset penalty function, x_t−1 and y_t−1 represent the coordinates of the feature point in the last image frame respectively, mean_dx, mean_dy represent the positional distance between the matched feature points in the adjacent images before the current image, and h represents the mapping transformation information.

It should be noted that independent variables and a function structure of the F1 function may be set according to the actual situation, aiming at coping with repeated textures, and improving the matching accuracy in the case of repeated textures in the image.

In this implementation, the preset penalty function may be flexibly set to determine the penalty information corresponding to each feature point in the target area, which improves the flexibility and practicability of information determination.

In some alternative implementations of the present embodiment, the executing body may perform the above third step as follows:

determining the matching information, by using a cross-checking strategy based on the initial matching information and the penalty information between the feature point in the last image frame and the feature point in the target area corresponding to the feature point.

The cross-checking strategy represents feature point matching in the forward and reverse directions respectively. Only when a same pair of feature points can be obtained by matching in both of the directions, can the two feature points be determined as matched. As an example, the third image frame is mapped to the viewing angle of the second image frame to obtain a mapping image, and matching information between the second image frame and the mapping image of the third image frame is determined based on the present disclosure; and the second image frame is mapped to the viewing angle of the third image frame to obtain a mapping image, and matching information between the third image frame and the mapping image of the second image frame is determined based on the present disclosure; when the two types of matching information are consistent, the matching information can be determined as correct matching information. Based on the cross-checking strategy, this implementation further improves the accuracy of the obtained matching information.

Step 204 includes determining mapping transformation information between the current image and the last image frame, based on the matching information.

In the present embodiment, the executing body may determine the mapping transformation information between the current image and the last image frame, based on the matching information.

As an example, on the basis of the matching information of two adjacent image frames, the executing body may obtain a homography matrix between the two adjacent image frames through RANSAC (Random sample consensus).

The mapping transformation information may be used for stitching the current image and the last image frame, and may also be used as the mapping transformation information by which the next image frame of the current image obtains a corresponding mapping image.

In some alternative implementations of the present embodiment, the executing body may also stitch the images in the image sequence based on mapping transformation information between adjacent images in the image sequence.

Based on fast and accurate feature matching, this implementation improves the efficiency and accuracy of image stitching, so that the present disclosure may be applied to fast scanning scenarios, and the scope of application is expanded.

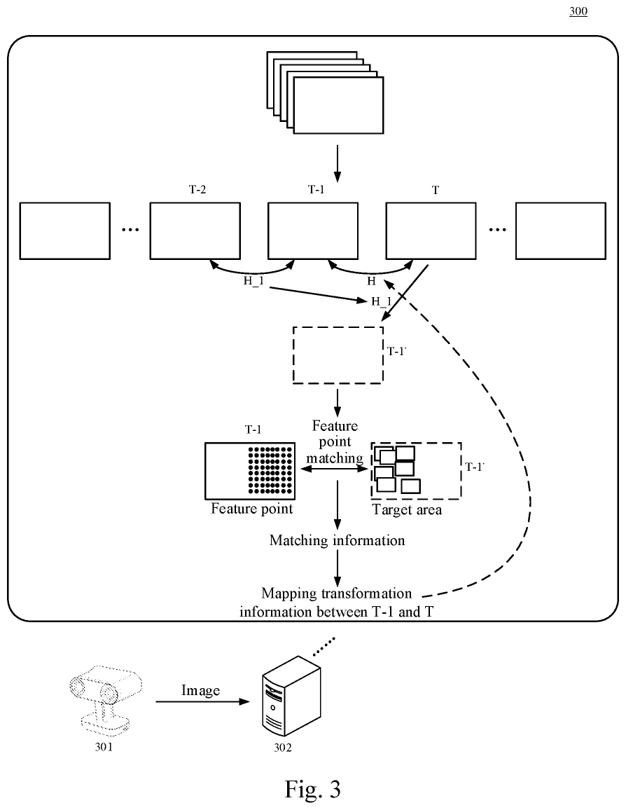

With further reference to FIG. 3, FIG. 3 is a schematic diagram 300 of an application scenario of the method for matching an image feature point according to the present embodiment. In the application scenario of FIG. 3, a text scanning device 301 scans text information in a file to obtain an image sequence including a plurality of images. A server 302 performs the following operations for the images in the acquired image sequence: obtaining a mapping image T−1′ of a current image T based on mapping transformation information H_1 between adjacent images T−1, T−2 before the current image T; determining in the mapping image T−1′ a target area for matching with a feature point in a last image frame T−1 prior to the current image T; matching the feature point in the last image frame T−1 with a feature point in the target area corresponding to the feature point, to determine matching information between the feature point of the current image T and the feature point of the last image frame T−1; and determining mapping transformation information H between the current image T and the last image frame T−1, based on the matching information. In this way, the matching information and the mapping transformation information of all adjacent images in the image sequence may be obtained.

In the present embodiment, a method for feature point matching between adjacent images in an image sequence is provided. The target area in the mapping image of the current image for matching with the feature point in the last image frame of the current image is determined based on motion tracking information between preceding adjacent images. The feature point in the last image frame is matched with the feature point in the corresponding target area, which reduces the amount of information calculation, and improves the accuracy and efficiency of feature point matching.

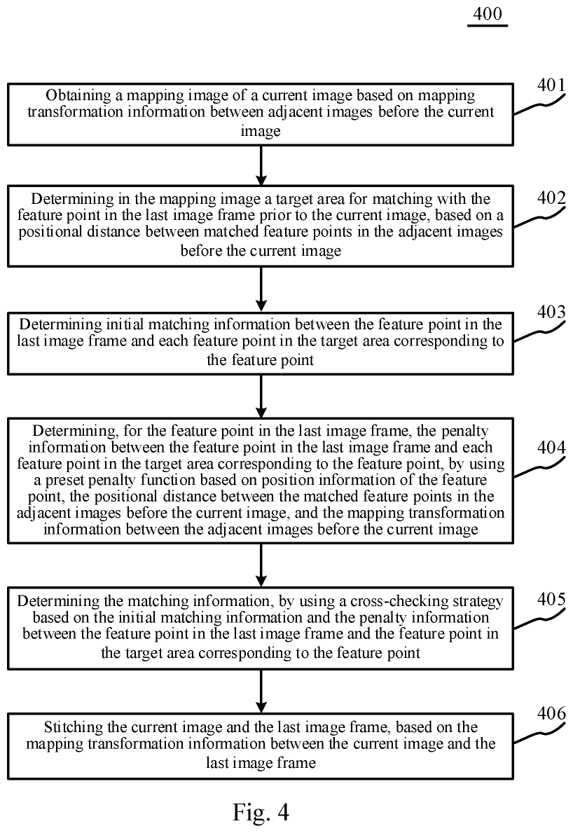

With further reference to FIG. 4, a schematic flow 400 of a method embodiment for image feature point matching according to the method of the present disclosure is shown, for images in an acquired image sequence, performing the following steps.

Step 401 includes obtaining a mapping image of a current image based on mapping transformation information between adjacent images before the current image.

Step 402 includes determining in the mapping image a target area for matching with the feature point in the last image frame prior to the current image, based on a positional distance between matched feature points in the adjacent images before the current image.

Step 403 includes determining initial matching information between the feature point in the last image frame and each feature point in the target area corresponding to the feature point.

Step 404 includes determining, for the feature point in the last image frame, the penalty information between the feature point in the last image frame and each feature point in the target area corresponding to the feature point, by using a preset penalty function based on position information of the feature point, the positional distance between the matched feature points in the adjacent images before the current image, and the mapping transformation information between the adjacent images before the current image.

The preset penalty function represents a corresponding relationship between the motion information of the scanning process and the penalty information.

Step 405 includes determining the matching information, by using a cross-checking strategy based on the initial matching information and the penalty information between the feature point in the last image frame and the feature point in the target area corresponding to the feature point.

Step 406 includes stitching the current image and the last image frame, based on the mapping transformation information between the current image and the last image frame.

It can be seen from the present embodiment that, compared with the embodiment corresponding to FIG. 2, the flow 400 of the method for image feature point matching in the present embodiment describes the process of determining the target area corresponding to the feature point, the process of determining the penalty information corresponding to each feature point in the target area and the process of real-time image stitching, improves the accuracy and efficiency of feature matching and image stitching.

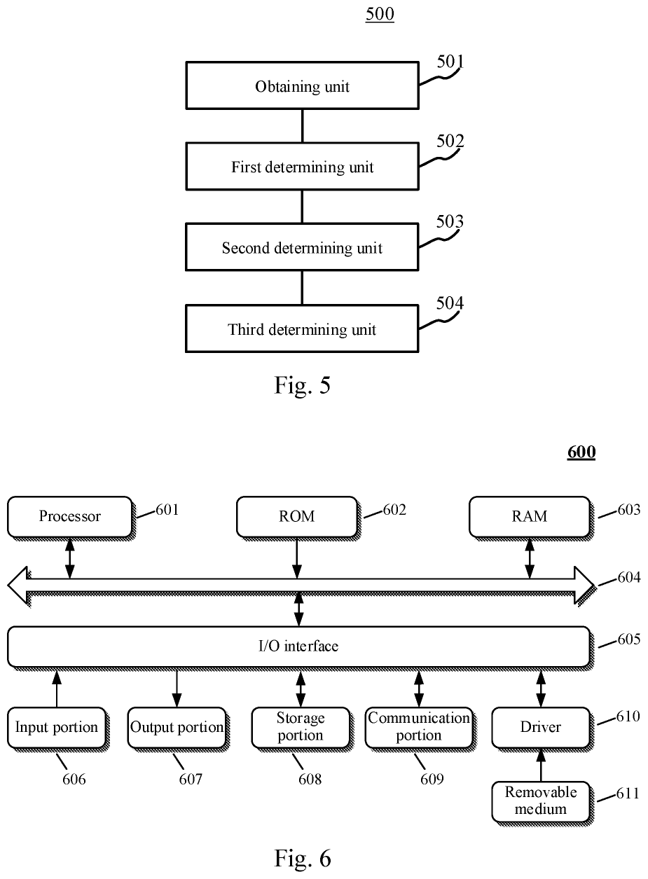

With further reference to FIG. 5, as an implementation of the method shown in the above figures, the present disclosure provides an embodiment of an apparatus for matching an image feature point. The apparatus embodiment corresponds to the method embodiment as shown in FIG. 2. The apparatus may be applied to various electronic devices.

As shown in FIG. 5, the apparatus for matching an image feature point performs the following operations for images in an acquired image sequence through units as follows: an obtaining unit 501, configured to obtain a mapping image of a current image based on mapping transformation information between adjacent images before the current image; a first determining unit 502, configured to determine in the mapping image a target area for matching with a feature point in a last image frame prior to the current image; a second determining unit 503, configured to match the feature point in the last image frame with a feature point in the target area corresponding to the feature point, to determine matching information between the feature point of the current image and the feature point of the last image frame; and a third determining unit 504, configured to determine mapping transformation information between the current image and the last image frame, based on the matching information.

In some alternative implementations of the present embodiment, the first determining unit 502 is further configured to: determine in the mapping image the target area for matching with the feature point in the last image frame prior to the current image, based on a positional distance between matched feature points in the adjacent images before the current image.

In some alternative implementations of the present embodiment, the second determining unit 503 is further configured to: determine initial matching information between the feature point in the last image frame and each feature point in the target area corresponding to the feature point; determine penalty information between the feature point in the last image frame and each feature point in the target area corresponding to the feature point, based on motion information of a scanning process of the adjacent images before obtaining the current image; and determine the matching information, based on the initial matching information and the penalty information between the feature point in the last image frame and each feature point in the target area corresponding to the feature point.

In some alternative implementations of the present embodiment, the second determining unit 503 is further configured to: determine, for the feature point in the last image frame, the penalty information between the feature point in the last image frame and each feature point in the target area corresponding to the feature point, by using a preset penalty function based on position information of the feature point, the positional distance between the matched feature points in the adjacent images before the current image, and the mapping transformation information between the adjacent images before the current image, where the preset penalty function represents a corresponding relationship between the motion information of the scanning process and the penalty information.

In some alternative implementations of the present embodiment, the second determining unit 503 is further configured to: determine the matching information, by using a cross-checking strategy based on the initial matching information and the penalty information between the feature point in the last image frame and the feature point in the target area corresponding to the feature point.

In some alternative implementations of the present embodiment, the apparatus further includes: a stitching unit (not shown in the figure), configured to stitch the images in the image sequence based on mapping transformation information between adjacent images in the image sequence.

In the present embodiment, an apparatus for feature point matching between adjacent images in an image sequence is provided. In the mapping image of the current image, the target area for matching with the feature point in the last image frame of the current image is determined based on motion tracking information between preceding adjacent images. The feature point in the last image frame is matched with the feature point in the corresponding target area, which reduces the amount of information calculation, and improves the accuracy and efficiency of feature point matching.

According to an embodiment of the present disclosure, the present disclosure also provides an electronic device, the electronic device including: at least one processor; and a memory communicatively connected to the at least one processor; where, the memory stores instructions executable by the at least one processor, and the instructions, when executed by the at least one processor, cause the at least one processor to implement the method for matching an image feature point as described in any of the above embodiments.

According to an embodiment of the present disclosure, the present disclosure also provides a readable storage medium, the readable storage medium storing computer instructions, the computer instructions are used to cause the computer to implement the method for matching an image feature point as described in any of the above embodiments.

An embodiment of the present disclosure provides a computer program product, the computer program, when executed by a processor, implements the method for matching an image feature point as described in any of the above embodiments.

FIG. 6 shows a schematic block diagram of an example electronic device 600 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, the device 600 includes a computing unit 601, which may perform various appropriate actions and processing, based on a computer program stored in a read-only memory (ROM) 602 or a computer program loaded from a storage unit 608 into a random access memory (RAM) 603. In the RAM 603, various programs and data required for the operation of the device 600 may also be stored. The computing unit 601, the ROM 602, and the RAM 603 are connected to each other through a bus 604. An input/output (I/O) interface 605 is also connected to the bus 604.

A plurality of components in the device 600 are connected to the I/O interface 605, including: an input unit 606, for example, a keyboard and a mouse; an output unit 607, for example, various types of displays and speakers; the storage unit 608, for example, a disk and an optical disk; and a communication unit 609, for example, a network card, a modem, or a wireless communication transceiver. The communication unit 609 allows the device 600 to exchange information/data with other devices over a computer network such as the Internet and/or various telecommunication networks.

The computing unit 601 may be various general-purpose and/or dedicated processing components having processing and computing capabilities. Some examples of the computing unit 601 include, but are not limited to, central processing unit (CPU), graphics processing unit (GPU), various dedicated artificial intelligence (AI) computing chips, various computing units running machine learning model algorithms, digital signal processor (DSP), and any appropriate processors, controllers, microcontrollers, etc. The computing unit 601 performs the various methods and processes described above, such as the method for matching an image feature point. For example, in some embodiments, the method for matching an image feature point may be implemented as a computer software program, which is tangibly included in a machine readable medium, such as the storage unit 608. In some embodiments, part or all of the computer program may be loaded and/or installed on the device 600 via the ROM 602 and/or the communication unit 609. When the computer program is loaded into the RAM 603 and executed by the computing unit 601, one or more steps of the method for matching an image feature point described above may be performed. Alternatively, in other embodiments, the computing unit 601 may be configured to perform the method for matching an image feature point by any other appropriate means (for example, by means of firmware).

Various embodiments of the systems and technologies described above herein may be implemented in digital electronic circuit systems, integrated circuit systems, field programmable gate arrays (FPGAs), application specific integrated circuits (ASICs), application specific standard products (ASSPS), system on chip (SOC), load programmable logic devices (CPLDs), computer hardware, firmware, software, and/or combinations thereof. These various embodiments may include being implemented in one or more computer programs that may be executed and/or interpreted on a programmable system including at least one programmable processor, which may be a dedicated or general programmable processor that may receive data and instructions from a storage system, at least one input device, and at least one output device, and transmit data and instructions to the storage system, the at least one input device, and the at least one output device.

The program code for implementing the methods of the present disclosure may be written in any combination of one or more programming languages. These program codes can be provided to the processor or controller of general computer, dedicated computer or other programmable data processing device, so that when executed by the processor or controller, the program code enables the functions/operations specified in the flow chart and/or block diagram to be implemented. The program code can be executed completely on the machine, partially on the machine, partially on the machine and partially on the remote machine as a separate software package, or completely on the remote machine or server.

In the context of the present disclosure, a machine readable medium may be a tangible medium which may contain or store a program for use by, or used in combination with, an instruction execution system, apparatus or device. The machine readable medium may be a machine readable signal medium or a machine readable storage medium. The computer readable medium may include, but is not limited to, electronic, magnetic, optical, electromagnetic, infrared, or semiconductor systems, apparatuses, or devices, or any appropriate combination of the above. A more specific example of the machine readable storage medium will include an electrical connection based on one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any appropriate combination of the above.

To provide interaction with a user, the systems and technologies described herein may be implemented on a computer that is provided with: a display apparatus (e.g., a CRT (cathode ray tube) or an LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or tactile feedback); and an input may be received from the user in any form (including an acoustic input, a voice input, or a tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server can be a cloud server, also known as cloud computing server or cloud host. It is a host product in the cloud computing service system to solve the defects of difficult management and weak business scalability in the traditional physical host and VPS service (“virtual private server”, or “VPS”). The server may alternatively be a distributed system server or a blockchain server.

According to the technical solution of the embodiments of the present disclosure, a method for feature point matching between adjacent images in an image sequence is provided. In the mapping image of the current image, the target area for matching with the feature point in the last image frame of the current image is determined based on motion tracking information between preceding adjacent images. The feature point in the last image frame is matched with the feature point in the corresponding target area, which reduces the amount of information calculation, and improves the accuracy and efficiency of feature point matching.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for matching an image feature point, wherein the method comprises: for images in an acquired image sequence, performing operations comprising:
obtaining a mapping image of a current image based on mapping transformation information between adjacent images before the current image;
determining in the mapping image a target area for matching with a feature point in a last image frame prior to the current image;
matching the feature point in the last image frame with a feature point in the target area corresponding to the feature point, to determine matching information between the feature point of the current image and the feature point of the last image frame; and
determining mapping transformation information between the current image and the last image frame, based on the matching information.

2. The method according to claim 1, wherein determining in the mapping image the target area for matching with the feature point in the last image frame prior to the current image comprises:
determining in the mapping image the target area for matching with the feature point in the last image frame prior to the current image, based on a positional distance between matched feature points in the adjacent images before the current image.

3. The method according to claim 1, wherein matching the feature point in the last image frame with the feature point in the target area corresponding to the feature point, to determine the matching information between the feature point of the current image and the feature point of the last image frame comprises:
determining initial matching information between the feature point in the last image frame and each feature point in the target area corresponding to the feature point;
determining penalty information between the feature point in the last image frame and each feature point in the target area corresponding to the feature point, based on motion information of a scanning process of the adjacent images before obtaining the current image; and
determining the matching information, based on the initial matching information and the penalty information between the feature point in the last image frame and each feature point in the target area corresponding to the feature point.

4. The method according to claim 3, wherein determining the penalty information between the feature point in the last image frame and each feature point in the target area corresponding to the feature point, based on motion information of the scanning process of the adjacent images before obtaining the current image comprises:
determining, for the feature point in the last image frame, the penalty information between the feature point in the last image frame and each feature point in the target area corresponding to the feature point, by using a preset penalty function based on position information of the feature point, the positional distance between the matched feature points in the adjacent images before the current image, and the mapping transformation information between the adjacent images before the current image, wherein the preset penalty function represents a corresponding relationship between the motion information of the scanning process and the penalty information.

5. The method according to claim 3, wherein determining the matching information, based on the initial matching information and the penalty information between the feature point in the last image frame and each feature point in the target area corresponding to the feature point comprises:
determining the matching information, by using a cross-checking strategy based on the initial matching information and the penalty information between the feature point in the last image frame and the feature point in the target area corresponding to the feature point.

6. The method according to claim 1, wherein the method further comprises:
stitching the images in the image sequence based on mapping transformation information between adjacent images in the image sequence.

7. An electronic device, comprising:
at least one processor; and
a memory communicatively connected to the at least one processor; wherein,
the memory stores instructions executable by the at least one processor, and the instructions, when executed by the at least one processor, cause the at least one processor to perform operations comprising:
for images in an acquired image sequence:
obtaining a mapping image of a current image based on mapping transformation information between adjacent images before the current image;
determining in the mapping image a target area for matching with a feature point in a last image frame prior to the current image;
matching the feature point in the last image frame with a feature point in the target area corresponding to the feature point, to determine matching information between the feature point of the current image and the feature point of the last image frame; and
determining mapping transformation information between the current image and the last image frame, based on the matching information.

8. The electronic device according to claim 7, wherein determining in the mapping image the target area for matching with the feature point in the last image frame prior to the current image comprises:
determining in the mapping image the target area for matching with the feature point in the last image frame prior to the current image, based on a positional distance between matched feature points in the adjacent images before the current image.

9. The electronic device according to claim 7, wherein matching the feature point in the last image frame with the feature point in the target area corresponding to the feature point, to determine the matching information between the feature point of the current image and the feature point of the last image frame comprises:
determining initial matching information between the feature point in the last image frame and each feature point in the target area corresponding to the feature point;
determining penalty information between the feature point in the last image frame and each feature point in the target area corresponding to the feature point, based on motion information of a scanning process of the adjacent images before obtaining the current image; and
determining the matching information, based on the initial matching information and the penalty information between the feature point in the last image frame and each feature point in the target area corresponding to the feature point.

10. The electronic device according to claim 9, wherein determining the penalty information between the feature point in the last image frame and each feature point in the target area corresponding to the feature point, based on motion information of the scanning process of the adjacent images before obtaining the current image comprises:
determining, for the feature point in the last image frame, the penalty information between the feature point in the last image frame and each feature point in the target area corresponding to the feature point, by using a preset penalty function based on position information of the feature point, the positional distance between the matched feature points in the adjacent images before the current image, and the mapping transformation information between the adjacent images before the current image, wherein the preset penalty function represents a corresponding relationship between the motion information of the scanning process and the penalty information.

11. The electronic device according to claim 9, wherein determining the matching information, based on the initial matching information and the penalty information between the feature point in the last image frame and each feature point in the target area corresponding to the feature point comprises:
determining the matching information, by using a cross-checking strategy based on the initial matching information and the penalty information between the feature point in the last image frame and the feature point in the target area corresponding to the feature point.

12. The electronic device according to claim 7, wherein the operations further comprise:
stitching the images in the image sequence based on mapping transformation information between adjacent images in the image sequence.

13. A non-transitory computer readable storage medium storing computer instructions, wherein the computer instructions when executed by a computer cause the computer to perform operations comprising:
for images in an acquired image sequence:
obtaining a mapping image of a current image based on mapping transformation information between adjacent images before the current image;
determining in the mapping image a target area for matching with a feature point in a last image frame prior to the current image;
matching the feature point in the last image frame with a feature point in the target area corresponding to the feature point, to determine matching information between the feature point of the current image and the feature point of the last image frame; and
determining mapping transformation information between the current image and the last image frame, based on the matching information.

14. The storage medium according to claim 13, wherein determining in the mapping image the target area for matching with the feature point in the last image frame prior to the current image comprises:
determining in the mapping image the target area for matching with the feature point in the last image frame prior to the current image, based on a positional distance between matched feature points in the adjacent images before the current image.

15. The storage medium according to claim 13, wherein matching the feature point in the last image frame with the feature point in the target area corresponding to the feature point, to determine the matching information between the feature point of the current image and the feature point of the last image frame comprises:
determining initial matching information between the feature point in the last image frame and each feature point in the target area corresponding to the feature point;
determining penalty information between the feature point in the last image frame and each feature point in the target area corresponding to the feature point, based on motion information of a scanning process of the adjacent images before obtaining the current image; and
determining the matching information, based on the initial matching information and the penalty information between the feature point in the last image frame and each feature point in the target area corresponding to the feature point.

16. The storage medium according to claim 15, wherein determining the penalty information between the feature point in the last image frame and each feature point in the target area corresponding to the feature point, based on motion information of the scanning process of the adjacent images before obtaining the current image comprises:
determining, for the feature point in the last image frame, the penalty information between the feature point in the last image frame and each feature point in the target area corresponding to the feature point, by using a preset penalty function based on position information of the feature point, the positional distance between the matched feature points in the adjacent images before the current image, and the mapping transformation information between the adjacent images before the current image, wherein the preset penalty function represents a corresponding relationship between the motion information of the scanning process and the penalty information.

17. The storage medium according to claim 15, wherein determining the matching information, based on the initial matching information and the penalty information between the feature point in the last image frame and each feature point in the target area corresponding to the feature point comprises:
determining the matching information, by using a cross-checking strategy based on the initial matching information and the penalty information between the feature point in the last image frame and the feature point in the target area corresponding to the feature point.

18. The storage medium according to claim 13, wherein the operations further comprise:
stitching the images in the image sequence based on mapping transformation information between adjacent images in the image sequence.
